(19) United States
(12) Patent Application Publication
(10) Pub. No.: US 2009/0259489 A1
(43) Pub. Date: Oct. 15, 2009

(54) INTEGRATED DATABASE SYSTEM OF GENOME INFORMATION AND CLINICAL INFORMATION AND A METHOD FOR CREATING DATABASE INCLUDED THEREIN

(75) Inventors: Michio KIMURA, Saitama (JP); Terutaka Furuta, Aichi (JP); Takeshi Numano, Aichi (JP)

Correspondence Address: STEIN MCEWEN, LLP, 1400 EYE STREET, NW, SUITE 300, WASHINGTON, DC, 20005, US

(73) Assignees: NTT Data Tokai Corporation, Aichi (JP); Michio Kimura, Saitama (JP)

(21) Appl. No.: 12/208,381

(22) Filed: Sep. 11, 2008

(30) Foreign Application Priority Data
Sep. 12, 2007 (JP) 2007-237176

(51) Int. Cl. G06Q 50/00; G06F 17/30

(52) U.S. Cl. 705/3; 707/104.1; 707/3; 707/E17.014; 707/E17.009

(57) ABSTRACT

There is provided an integrated database system that incorporates genome information into a clinical information database contrary to conventional databases, while complying with guidelines preventing identification of a provider of the genome information, thereby enabling an easy search for a correlation between the genome information and clinical information and the like. The integrated database system includes an information database including a data storage unit for storing clinical information of a plurality of patients and genome information of at least a part of the plurality of patients. In the data storage unit, the clinical information does not include personal information that identifies the individual patients, and the genome information and the clinical information of the same patient are stored in association with each other by link information that does not identify the individual patients.

### BACKGROUND OF THE INVENTION

1. Field of the Invention

The present invention relates to an integrated database system that incorporates genome information into a clinical information database so as to enable an easy search for a correlation between the genome information and clinical information and the like, and a method for creating a database included in the integrated database system.

2. Description of Related Art

In recent years, the human genome and the genomes of various organisms have been analyzed, and sequencing of the entire human genome has already been completed. Further, studies are being conducted so as to apply genome information obtained through the genome analysis to the prevention, diagnosis, and treatment of diseases or the development of new drugs. To this end, genome information databases have been created that incorporate clinical information therein so as to enable a search for a correlation between a specific gene and a specific case (see Documents 1 and 2 below).

### [Document 1] Hamosh A, Scott A F, Amberger J, Valle D, McKusick V A, Online Mendelian Inheritance in Man (OMIM), Hum Mutat 15 (2000), pp. 57-61

### [Document 2] Stenson P. D., Ball E. V., Mort M., Phillips A. D., Shiel J. A., Thomas N. S., Abeysinghe S., Krawczak M., Cooper D. N., Human Gene Mutation Database (HGMD), Hum Mutat 21 (2003), pp. 577-581

However, for identification of a gene relevant to a specific illness, the conventional genome information databases as described above that incorporate clinical information therein require a researcher to select information on a patient afflicted with a disease that seems to be relevant to the gene from a clinical information database having a large amount of data and to input the selected information to the genome information databases. It is often the case that the researcher selects the clinical information by guesswork by trial and errors. Consequently, the conventional databases as described above have a problem that it takes time and labor for the researcher to select and input the clinical information, making it impossible to make efficient identification of a gene.

Meanwhile, guidelines have been established for the handling of the genome information so as to ensure that the genome information or information on its specimen cannot be linked to information on its provider. This is because the genome information is crucially private information on its provider. In order to reduce the burden of selecting and inputting the clinical information, the genome information may be incorporated into the clinical information database contrary to the conventional databases. However, for compliance with the above-described guidelines, it is required to make some contrivance to prevent identification of a provider of the genome information.

### SUMMARY OF THE INVENTION

With the foregoing in mind, it is an object of the present invention to provide an integrated database system that incorporates genome information into a clinical information database contrary to the conventional databases, while complying with the guidelines preventing identification of a provider of the genome information, thereby enabling an easy search for a correlation between the genome information and clinical information and the like. Further, it is an object to provide a method for creating a database included in the integrated database system.

In order to achieve the above-described object, an integrated database system of genome information and clinical information according to the present invention includes a database including a data storage unit for storing clinical information of a plurality of patients and genome information of at least a part of the plurality of patients. In the data storage unit, the clinical information does not include personal information that identifies the individual patients, and the genome information and the clinical information of the same patient are stored in association with each other by link information that does not identify the individual patients.

The database included in this integrated database system can be created by, for example, importing the genome information of at least a part of the patients of the clinical information into the clinical information as a replica of clinical data on an electronic medical record system. Thus, it becomes possible to save an operator from having to select the clinical information, and thus to identity a gene responsible for a specific illness or the like efficiently by using the abundant clinical data. Further, the clinical information does not include personal information that identifies the individual patients, and the clinical information and the genome information of the same patient are associated with each other by the link information that does not identify the individual patients. This makes it impossible to identify a provider of the genome information on the integrated database system, ensuring the anonymity of the provider of the genome information.

Further, in order to achieve the above-described object, a method for creating a database according to the present invention is one for creating a database that stores clinical information of a plurality of patients and genome information of at least a part of the plurality of patients in a data storage unit. The method includes the steps of: inputting the clinical information of the plurality of patients together with patient identification information peculiar to each of the patients and storing the clinical information in the data storage unit; substituting the patient identification information with link information that does not identify each of the individual patients based on predetermined conversion information; inputting the genome information of at least a part of the plurality of patients together with genome management information that identifies a provider of a specimen of the genome information and storing the genome information in the data storage unit; substituting the genome management information with the link information based on correspondence information between the genome management information and the patient identification information and the predetermined conversion information; deleting personal information that identifies each of the individual patients from the clinical information; and abandoning the correspondence information between the genome management information and the patient identification information and the predetermined conversion information.

According to the above-described method, the database is created by, for example, importing the genome information of at least a part of the patients of the clinical information into the clinical information as a replica of clinical data on an electronic medical record system. Thus, it becomes possible to save an operator from having to select the clinical information, and thus to identity a gene responsible for a specific illness or the like efficiently by using the abundant clinical data. Further, the clinical information does not include personal information that identifies the individual patients, the clinical information and the genome information of the same patient are associated with each other by the link information that does not identify the individual patients, and the correspondence information between the genome management information and the patient identification information and the conversion information are abandoned. This makes it impossible to identify a provider of the genome information from the information of this database, ensuring the anonymity of the provider of the genome information.

According to the present invention, it is possible to provide an integrated database system that incorporates genome information into a clinical information database contrary to conventional databases, while complying with guidelines preventing identification of a provider of the genome information, thereby enabling an easy search for a correlation between the genome information and clinical information and the like. Further, it is possible to provide a method for creating a database included in the integrated database system.

### BRIEF DESCRIPTION OF THE DRAWINGS

FIG. 1 is a block diagram showing a functional schematic configuration of an integrated database system according to an embodiment of the present invention.

FIG. 2 is a flowchart showing a procedure for creating/updating a database in the integrated database system.

FIG. 3 is an explanatory view showing an example of a search condition setting screen in the integrated database system.

FIG. 4 is an explanatory view showing an example of a search condition setting screen in the integrated database system.

FIG. 5 is an explanatory view showing an example of a search condition setting screen in the integrated database system.

FIG. 6 is an explanatory view showing an example of a search result screen in the integrated database system.

FIG. 7 is an explanatory view showing an example of a search condition setting screen in the integrated database system.

FIG. 8 is an explanatory view showing an example of a search condition setting screen in the integrated database system.

FIG. 9 is an explanatory view showing an example of a search result screen in the integrated database system.

### DETAILED DESCRIPTION OF THE INVENTION

Hereinafter, an embodiment of an integrated database system of genome information and clinical information according to the present invention will be exemplified, and its configuration and operation will be described with reference to the drawings.

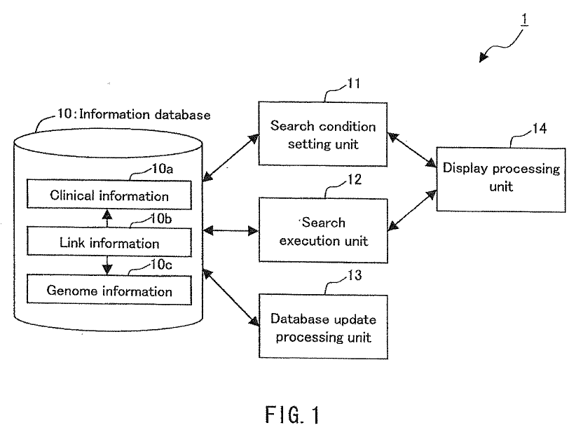

FIG. 1 is a block diagram showing a functional schematic configuration of an integrated database system according to an embodiment of the present invention. As shown in FIG. 1, an integrated database system 1 according to the present embodiment includes at least an information database 10, a search condition setting unit 11, a search execution unit 12, a database update processing unit 13, and a display processing unit 14. Although the integrated database system 1 according to the embodiment may be realized as a client-server system having at least the information database 10 on a server side, it also may be realized as a very compact system on one personal computer. The following description is directed to an exemplary case where the integrated database system 1 according to the embodiment is realized by a personal computer.

The information database 10 is created on a hard disk provided in a personal computer or various storage media attached to the personal computer. The search condition setting unit 11, the search execution unit 12, the database update processing unit 13, and the display processing unit 14 each are a functional block realized by a processor of the personal computer executing a predetermined program at a necessary timing. In other words, these functional blocks need not be mounted as individual hardware elements. The search condition setting unit 11 has a function of allowing a user to set conditions of searching the information database 10 by using an input/output interface of the personal computer. The search execution unit 12 searches the information database 10 in accordance with the search conditions set by the search condition setting unit 11, and extracts information according to the search conditions. When clinical information or genome information needs to be updated, the database update processing unit 13 obtains necessary information from the outside, and updates the contents of the information database 10. The display processing unit 14 instructs a display of the personal computer to display a search condition setting screen, a search result display screen, or the like.

As shown in FIG. 1, the information database 10 includes clinical information 10a on a large number of patients. Genome information 10c is information obtained from specimens provided by a part of the large number of patients. Under present circumstances, an analysis of the genome information requires enormous amounts of expense and time. However, when it becomes easier to analyze the genome information in the future, the genome information 10c may be stored for all the patients whose clinical information 10a is stored in the information database 10.

The clinical information 10a is generated from, for example, a replica (copy) of clinical data on an electronic medical record system in a hospital or the like. The clinical data on the electronic medical record system as a basis for the clinical information 10a includes various data on an illness of the patients, such as a name of a disease, examination information, medication information, progress information, and the like, as well as personal information that identifies the individual patients, such as patient's name, address, telephone number, patient code used in a hospital, health insurance card number, and the like. However, all the personal information is deleted from the clinical information 10a of the integrated database system 1 so that the individual patients cannot be identified.

The genome information 10c is imported from a genome information database independent of the integrated database system 1. In the genome information database, a provider of each specimen can be identified by a genome management number. However, the genome management number is deleted from the genome information 10c in the integrated database system 1 so that the individual provider cannot be identified. Instead, in the integrated database system 1, the clinical information 10a and the genome information 10c of the same patient are associated with each other by link information 10b given in the integrated database system 1 uniquely.

The link information 10b is generated by, for example, converting the patient code in the electronic medical record system in accordance with a predetermined conversion rule. Here, the conversion rule ensures that it is impossible or extremely difficult and accordingly virtually impossible to obtain the original patient code only from the link information 10b on the integrated database system 1. For example, the conversion rule may be a conversion table for converting the patient code into a random number, which may then be used as the link information 10b. The conversion rule (in the above-described example, the conversion table) used to generate the link information 10b is abandoned from the integrated database system 1, and it is managed stringently by a third party outside the integrated database system 1.

In this manner, the integrated database system 1 ensures the anonymity of a provider of the genome information 10c by satisfying the following three conditions. That is, (1) the clinical information 10a does not include the personal information that identifies the individual patients, (2) the genome information 10c does not include the genome management number that identifies a provider of a specimen, and (3) the clinical information 10a and the genome information 10c of the same patient are associated with each other by the link information 10b given in the integrated database system 1 uniquely.

FIG. 1 shows the clinical information 10a, the link information 10b, and the genome information 10c schematically. However, these pieces of information may have an arbitrary data structure and file configuration when being stored in the information database 10. The database update processing unit 13 stores the clinical information 10a, the link information 10b, and the genome information 10c in the information database 10, and updates the information database 10.

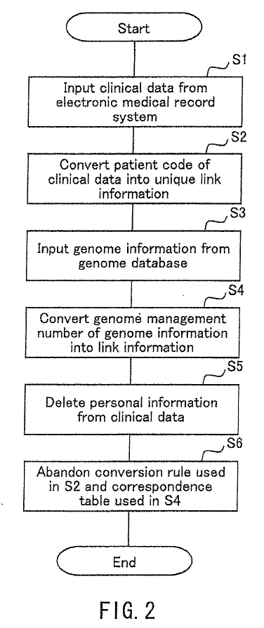

With reference to FIG. 2, a description will be given of a procedure for creating/updating the information database 10 by the database update processing unit 13 in the integrated database system 1. The following description is directed to a procedure for creating the information database 10 newly. However, the same procedure as described below basically is used also for updating the information database 10 using new clinical information or genome information.

Initially, the database update processing unit 13 copies clinical data from an electronic medical record system outside the integrated database system 1 (Step S1). The clinical data includes various data on an illness of a large number of patients, such as a name of a disease, examination information, medication information, progress information, and the like, as well as personal information that identifies the individual patients, such as patient's name, address, telephone number, patient code used in a hospital, health insurance card number, and the like. The clinical data may be copied from the electronic medical record system to the integrated database system 1 on-line by connecting the electronic medical record system and the integrated database system 1 via communication lines, or off-line via a recoding medium. The clinical data received from the electronic medical record system is stored in the information database 10 as the clinical information 10a.

Then, the database update processing unit 13 converts the patient code included in the clinical data into the link information 10b for use in the integrated database system 1 uniquely, by using a predetermined conversion rule (Step S2). For example, as described above, a conversion table for converting the patient code into a random number may be used as the conversion rule, so that the random number obtained by the conversion can be used as the link information 10b. Consequently, the clinical information 10a of the information database 10 is given the link information 10b instead of the patient code. The conversion rule such as a conversion table as described above is managed stringently by a third party, and it can be referred to by permission of the third party in the integrated database system 1 only in the case where the information database 10 is created/updated in the integrated database system 1.

After that, the database update processing unit 13 imports genome information from a genome information database outside the integrated database system 1 (Step S3). The genome information also may be imported on-line by connecting the genome information database and the integrated database system 1 via communication lines, or off-line via a recoding medium. The imported genome information 10c is stored in the information database 10. It should be noted that the genome information 10c at this time includes a genome management number that identifies a provider of a specimen of the genome information.

Then, the database update processing unit 13 converts the genome management number in the imported genome information 10c into the link information 10b (Step S4). To this end, the database update processing unit 13 initially converts the genome management number into the patient code temporarily with reference to a table showing a correspondence between the genome management number and the patient code used in the electronic medical record system. The table showing a correspondence between the genome management number and the patient code is managed stringently by an administrator such as an agency that has conducted genome analysis and a creator of the genome information database, and it can be referred to by permission of the administrator in the integrated database system 1 only in the case where the information database 10 is created/updated in the integrated database system 1. The database update processing unit 13 further converts the patient code converted from the genome management number as described above into the link information 10b with reference to the conversion table used in Step S2. Consequently, the genome management number included in the genome information 10c is substituted with the same link information 10b as that given in Step S2 to the clinical information 10a of the same person as a provider of a specimen of the genome information 10c.

Thereafter, the database update processing unit 13 deletes the personal information that identifies the individual patients from the clinical data received from the electronic medical record system (Step S5). The personal information to be deleted includes patient's name, address, telephone number, fax number, mail address, office name, health insurance card number, and the like. Here, the personal information is deleted after Steps S1 to S4. However, the personal information may be deleted in advance on an electronic medical record system side when the clinical data is copied from the electronic medical record system in Step S1.

Finally, the database update processing unit 13 deletes the conversion table (conversion rule) used in Step S2 and the correspondence table used in Step S4 from the integrated database system 1 (Step S6).

By the above-described processing, the information database 10 in the integrated database system 1 can be created/updated based on the clinical data in the electronic medical record system and the genome information in the genome information database.

As described above, the clinical information 10a of the information database 10 includes the clinical data on a plurality of patients. Further, the genome information 10c of the information database 10 includes the genome information obtained from at least a part of the plurality of patients. Thus, it is possible both to search the information database 10 only for the patients whose genome information is registered by setting a condition regarding the genome information, and to search for all the patients without setting a condition regarding the genome information. Accordingly, by comparing results of these searches, it becomes possible to conduct verification with high accuracy.

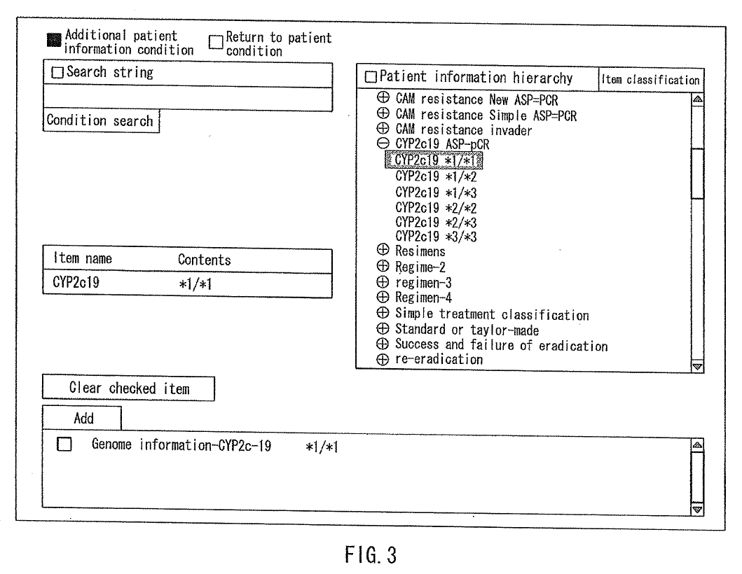

Hereinafter, specific examples of search processing in the integrated database system 1 will be described with reference to FIGS. 3 to 9.

First, a description will be given of a first specific example of ascertaining the occurrence of side effects due to the administration of a PPI (proton pump inhibitor) depending on the difference in genotypes of CYP2C19. The genotype (RM, IM, or PM) of CYP2C19, the administration of the PPI, and the occurrence of side effects (hepatopathy etc.) (a specific abnormal test value) are set as search conditions, and the information database 10 is searched based thereon. By comparing the number of patients who match these search conditions, the relationship between the genotype and the occurrence of side effects is examined. Specifically, with respect to each of the genotypes of CYP2C19, when the ratio of the number of patients differs from the ratio of the number of patients who experience the side effects, it can be considered that there is a correlation between the genotype and the side effects. For example, with respect to each of the genotypes of CYP2C19, when the ratio of the number of patients is RM:IM:PM=100:100:100, while the ratio of the number of patients who experience the side effects is RM′:IM′:PM′=2:4:8, a correlation between the genotype and the side effects is suspected since the number of patients who experience the side effects varies as compared with the number of patients with respect to each of the genotypes. On the other hand, when the ratio of the number of patients who experience the side effects is RM″:IM″:PM″5:4:5, for example, it is considered that there is not much correlation between the genotype and the occurrence of the side effects.

It should be noted that RM as one of the genotypes of CYP2C19 as above is an abbreviation of Rapid metabolizer, and it has been found that a person who metabolizes fast is of this genotype. Further, RM is described as *1/*1 in the genome information 10c. Similarly, IM (Intermediate metabolizer) as one of the genotypes of CYP2C19 is a genotype of a person having an intermediate metabolic rate, and it is described as *1/*2 or *1/*3 in the genome information 10c. Further, PM (Poor metabolizer) as one of the genotypes of CYP2C19 is a genotype of a person who metabolizes slowly, and it is described as *2/*2, *2/*3, or *3/*3 in the genome information 10c.

The search conditions are set by the search condition setting unit 11. The search condition setting unit 11 instructs the display processing unit 14 to display a search condition setting screen as shown in FIG. 3, for example. The search condition setting screen in FIG. 3 is a screen for setting genome information to be searched for. Here, an operator allows CYP2C19 and the genotypes of CYP2C19 as well to appear in an upper right subwindow on the screen, and selects one of the genotypes. In this manner, the selection can be added to the search conditions. Namely, the search condition setting unit 11 allows all the genome information registered in the information database 10 as the genome information 10c to appear in the upper right subwindow on the search condition setting screen in FIG. 3, so that the operator can select one of the genotypes. In the example shown in FIG. 3, the operator selects RM (*1/*1) among the genotypes of CYP2C19, and it is added to the search conditions. The search condition setting unit 11 and the display processing unit 14 allow the selected search condition to appear in a lower subwindow on the screen.

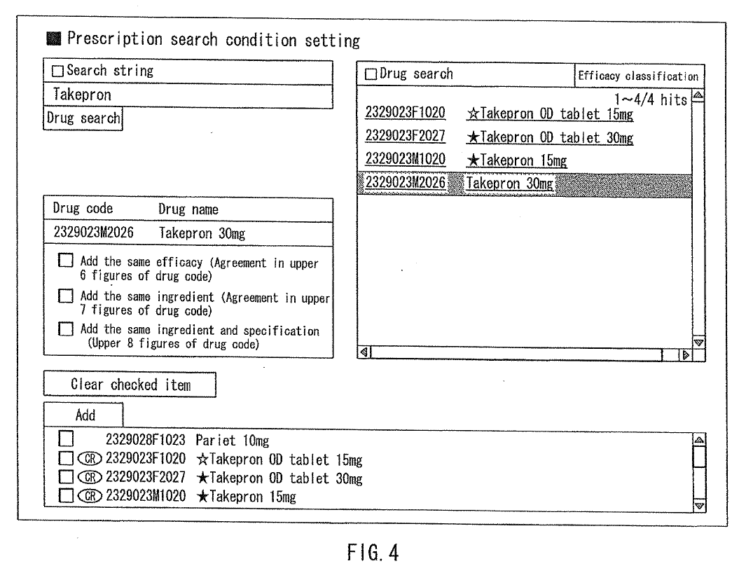

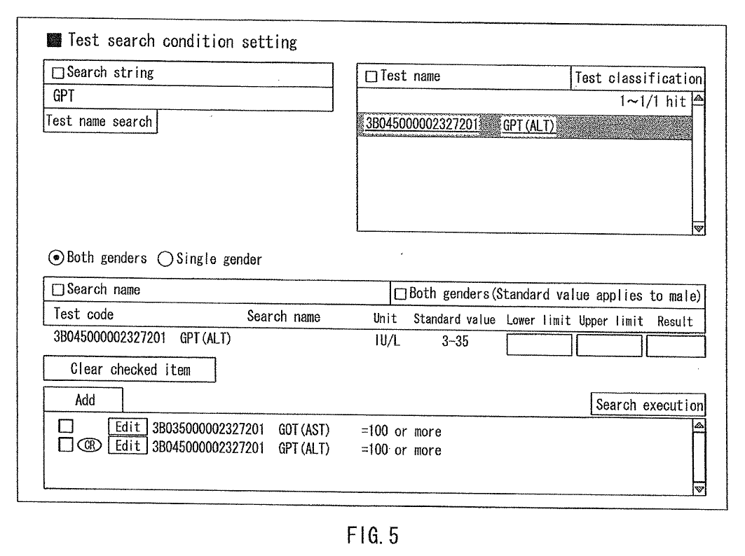

Then, the search condition setting unit 11 allows a search condition setting screen for setting clinical information to be searched for to be displayed. FIG. 4 shows an exemplary screen for setting as a search condition an administered drug as one of the clinical information. A list of PPIs (proton pump inhibitors) appears in an upper right subwindow on the screen in FIG. 4. The operator can select a desired drug from the list and add it to the search conditions. FIG. 5 shows a search condition setting screen for setting a test value as one of the clinical information. On the search condition setting screen in FIG. 5, when a search string (in this case, a GPT) of a test name is input to an upper left subwindow, test names corresponding to the search string appear in an upper right subwindow. Here, when the operator selects one of the test names, a test code, the test name, a unit of the test value, a standard value, and the like appear in a middle subwindow. Further, the operator can designate a range of an abnormal value to be searched for in the middle subwindow. When the range of the abnormal value is designated in the middle subwindow, the search condition appears in a lower subwindow. In the example in FIG. 5, two search conditions of “100 or more GOT (AST)” and “100 or more GPT (ALT)” are designated as OR conditions. It is understood that a plurality of conditions also may be designated as AND conditions or the like.

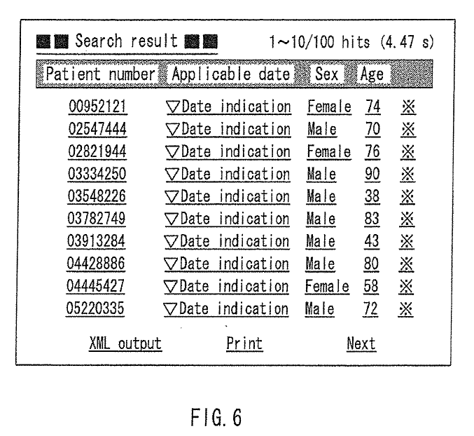

When the search conditions are set as described above, the operator clicks a search execution button appearing on the search condition setting screen. Accordingly, the search execution unit 12 searches the information database 10 in accordance with the set search conditions. Based on a result of the search, the search execution unit 12 generates a search result screen showing necessary information extracted from the clinical information of patients who match the above-described search conditions, as shown in FIG. 6, for example, and allows the search result screen to be displayed via the display processing unit 14. On the search result screen in FIG. 6, numbers shown under “patient number” correspond to the link information 10b given in the integrated database system 1 uniquely as described above.

Thereafter, the operator repeats searching, while changing the condition of the genotype of CPYP2C19, thereby examining the relationship between the genotype and the side effects from the number of patients who match each of the conditions.

Further, the following description is directed to a second specific example of ascertaining the occurrence of cancer depending on the difference in genotypes of MDR1. The genotype of three genetic single nucleotide polymorphisms (MDR1 1236, MDR1 2677, and MDR1 3435) existing in MDR1 (P-glycoprotein) and the occurrence of cancer (a name of a disease, a test value, etc.) are set as search conditions, and the information database 10 is searched based thereon. By comparing the number of patients who match the conditions with respect to each of the genotypes, the relationship between the genotype and the occurrence of cancer can be examined. Specifically, with respect to each of the genotypes of MDR1, when the ratio of the number of patients differs from the ratio of the number of patients who match the conditions, it can be considered that there is a correlation between the genotype and the occurrence of cancer. It should be noted that MDR1 1236 includes C/C, C/T, and T/T types, MDR1 2677 includes G/G, G/A, G/T, A/A, A/T, and T/T types, and MDR1 3435 includes C/C, C/T, and T/T types.

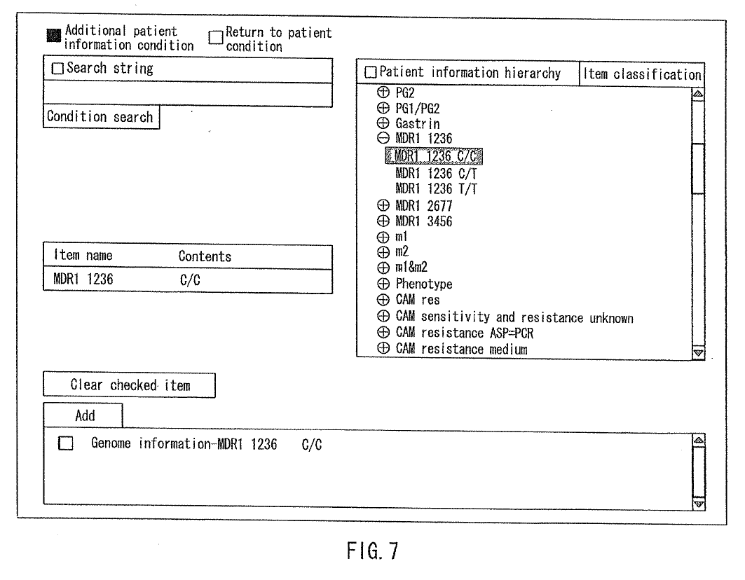

Initially, the search condition setting unit 11 allows a search condition setting screen for setting a genotype to be searched for to be displayed. FIG. 7 shows a search condition setting screen on which an operator selects MDR1 1236 (C/C) as the genotype of MDR1 and adds it to the search conditions.

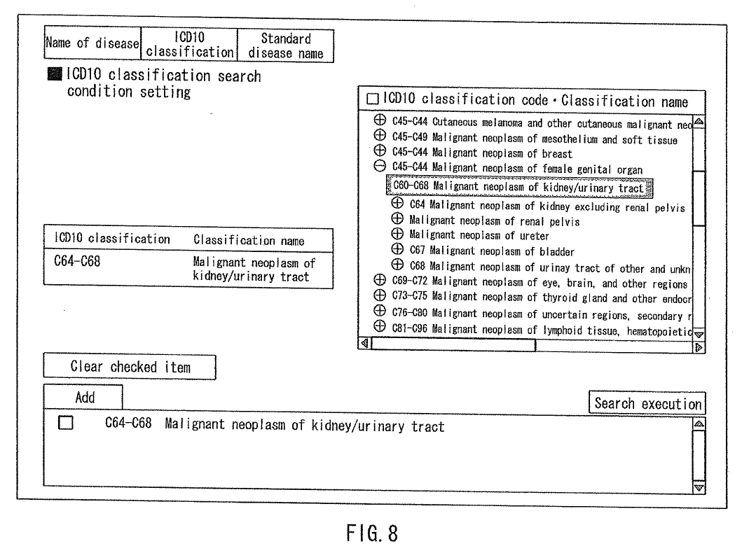

Then, the search condition setting unit 11 allows a search condition setting screen for setting clinical information to be searched for to be displayed. FIG. 8 shows a search condition setting screen on which the operator selects “Malignant neoplasm of kidney/urinary tract” of ICD10 classification as a disease name condition and adds it to the search conditions.

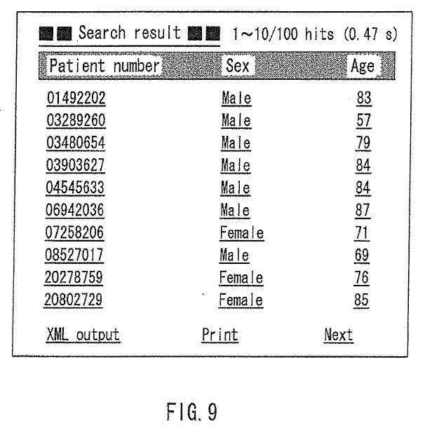

After setting the above-described search conditions, the operator clicks a search execution button. Accordingly, the search execution unit 12 searches the information database 10, and allows a search result to appear on a search result screen as shown in FIG. 9. Thereafter, the operator repeats searching, while changing the condition of the genotype of MDR1, thereby examining the relationship from the number of patients who match each of the conditions.

As described above, according to the integrated database system 1 of the present embodiment, the genome information is imported into the clinical information as a replica of clinical data on an electronic medical record system. Therefore, it becomes possible to identity a gene responsible for a specific illness or the like efficiently by using the abundant clinical data.

Further, although the information database 10 in the integrated database system 1 of the present embodiment includes a replica of clinical data on an electronic medical record system as the clinical information 10a, it does not include personal information that identifies individual patients, but includes the link information 10b given in the integrated database system 1 uniquely so as to associate the clinical information 10a and the genome information 10c of the same patient. This makes it impossible to identify a provider of the genome information 10c on the integrated database system 1, ensuring the anonymity of the provider of the genome information 10c.

The display screens in the above-described embodiment are shown only as examples. The screen display mode for carrying out the present invention is not limited to the above-described specific examples. Similarly, the format of the genome information is not limited to the examples shown in the present embodiment.

While the present invention has been described regarding a specific embodiment thereof, it will be apparent to those skilled in the art that numerous alternatives or modifications are possible. Accordingly, the embodiment disclosed in this application is to be considered as illustrative and not limiting. Various changes can be made without departing from the spirit and scope of the invention as set forth in the appended claims.

What is claimed is:

1. An integrated database system comprising a database including a data storage unit for storing clinical information of a plurality of patients and genome information of at least a part of the plurality of patients,
wherein in the data storage unit, the clinical information does not include personal information that identifies the individual patients, and the genome information and the clinical information of the same patient are stored in association with each other by link information that does not identify the individual patients.

2. The integrated database system according to claim 1, further comprising:
a search condition setting unit for setting a condition of searching the data storage unit; and
a search execution unit for searching the data storage unit in accordance with the search condition set by the search condition setting unit.

3. A method for creating a database that stores clinical information of a plurality of patients and genome information of at least a part of the plurality of patients in a data storage unit, the method comprising the steps of:
inputting the clinical information of the plurality of patients together with patient identification information peculiar to each of the patients and storing the clinical information in the data storage unit;
substituting the patient identification information with link information that does not identify each of the individual patients based on predetermined conversion information;
inputting the genome information of at least a part of the plurality of patients together with genome management information that identifies a provider of a specimen of the genome information and storing the genome information in the data storage unit;
substituting the genome management information with the link information based on correspondence information between the genome management information and the patient identification information and the predetermined conversion information;
deleting personal information that identifies each of the individual patients from the clinical information; and
abandoning the correspondence information between the genome management information and the patient identification information and the predetermined conversion information.

4. The method for creating a database according to claim 3, wherein the clinical information of the plurality of patients is obtained from an electronic medical record system.
